(19) United States
(12) Patent Application Publication
(10) Pub. No.: US 2017/0144930 A1
(43) Pub. Date: May 25, 2017

(54) OPTICAL FIBER PRODUCTION SYSTEM AND METHOD FOR PRODUCING COATED OPTICAL FIBER

(71) Applicant: CORNING INCORPORATED, Corning, NY (US)

(72) Inventor: Robert Clark Moore, Wilmington, NC (US)

(21) Appl. No.: 15/354,561

(22) Filed: Nov. 17, 2016

Related U.S. Application Data
(60) Provisional application No. 62/258,108, filed on Nov. 20, 2015.

(51) Int. Cl. C03C 25/10; G02B 6/02; C03B 37/02; G02B 6/44

(52) U.S. Cl. CPC C03C 25/106; G02B 6/4457; G02B 6/02395; C03B 37/02; C03C 2218/32

(57) ABSTRACT

An optical fiber production system is provided. The system includes a draw furnace from which an optical fiber is drawn along a first vertical pathway, at least one coating system where at least one coating is applied to the optical fiber and an irradiator in which the at least one coating is cured. The system also includes a fiber take-up system including a fiber storage spool, a whip shield that substantially surrounds the fiber storage spool and at least one light emitting diode (LED) positioned in the interior of the whip shield, wherein the at least one LED directs UV light to coated optical fiber in the fiber take-up system.

### CROSS-REFERENCE TO RELATED APPLICATIONS

This application claims the benefit of priority of U.S. Provisional Application Ser. No. 62/258,108 filed on Nov. 20, 2015, the content of which is relied upon and incorporated herein by reference in its entirety.

### FIELD

The present disclosure relates generally to methods and systems for producing coated optical fibers and, more particularly, to methods and systems for curing optical fiber coatings on an optical fiber draw tower take-up reel.

### BACKGROUND

Conventional techniques and manufacturing processes for producing optical fiber generally include drawing optical fiber downward from a draw furnace and along a linear pathway through multiple stages of production in an optical fiber draw tower. After being drawn from the draw furnace, the optical fiber is generally coated with an ultraviolet (UV)-curable material, such as an acrylate material, to protect the fiber and improve the optical characteristics of the fiber. Some optical fibers may have multiple coatings applied to the optical fiber. For instance, the optical fiber may have a primary coating disposed immediately adjacent the glass fiber while a secondary coating is applied around the primary coating. Each coating may serve a different function. For example, the primary coating may be used to improve the optical properties of the optical fiber while the secondary coating may be used to improve the durability of the optical fiber. The coatings are typically applied after the fiber is drawn from the furnace and cured on-line with ultraviolet light in a continuous process of drawing, coating and curing. The coated fiber is then wound onto reels for storage.

Curing of optical fiber may be a relatively slow step in the manufacturing process that limits the speed of the continuous process while increasing costs and decreasing energy efficiencies. Since there is a practical limit to the UV intensity derived from high power UV lamps, increases in draw speed are usually accompanied by longer, high power lamp systems that illuminate the coated fiber over a longer length. These lamp systems increase the costs associated with drawing processes both because of the expense of high power UV lamps and because of the use of more vertical space on the draw tower for curing. Even with the longer lamp systems, the coating is often exposed to the UV light for very short time periods (e.g.: less 100 milliseconds). Curing during the continuous process is also energy inefficient. Typically, the moving coated fiber is passed through one focus of a cylindrical elliptical reflector with a UV lamp at the other focus. However, the diameter of the focused UV light must be larger than the fiber diameter for easy alignment. This configuration, in combination with the short time periods of UV light exposure, results in only a small percent (e.g.: less than 1.0% of the UV light output from the UV lamp system) of the UV light being absorbed by the coating in a single illumination.

### SUMMARY

According to an embodiment of the present disclosure, an optical fiber production system is provided. The system includes a draw furnace from which an optical fiber is drawn along a first vertical pathway, at least one coating system where at least one coating is applied to the optical fiber and an irradiator in which the at least one coating is cured. The system also includes a fiber take-up system including a fiber storage spool, a whip shield that substantially surrounds the fiber storage spool and at least one light emitting diode (LED) positioned in the interior of the whip shield, wherein the at least one LED directs UV light to coated optical fiber in the fiber take-up system.

According to another embodiment of the present disclosure a method for producing a coated optical fiber is provided. The method includes drawing an optical fiber from a draw furnace along a first vertical pathway and applying at least one coating to the optical fiber with at least one coating system to form a coated optical fiber. The method also includes curing the at least one coating while drawing the coated optical fiber along the first vertical pathway. The method further includes winding the coated optical fiber onto a fiber storage spool of a fiber take-up system, wherein winding the optical fiber includes directing UV light from at least one LED to cure the at least one coating of the coated optical fiber.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The disclosure will be understood more clearly from the following description and from the accompanying figures, given purely by way of non-limiting example, in which:

FIG. 1 is a schematic illustration of an optical fiber production system according to embodiments of the present disclosure; and

FIG. 2 is a schematic illustration of an optical fiber production system according to embodiments of the present disclosure;

FIG. 3 is a schematic illustration of an optical fiber production system according to embodiments of the present disclosure;

FIG. 4 is a side elevation view of a fiber take-up system according to embodiments of the present disclosure;

FIG. 5 is a cross-section view of a fiber take-up system including at least one LED according to embodiments of the present disclosure; and

FIG. 6 is a front view of an interior wall of a fiber take-up system including at least one LED according to embodiments of the present disclosure.

### DETAILED DESCRIPTION

Reference will now be made in detail to the present embodiment(s), an example(s) of which is/are illustrated in the accompanying drawings. Whenever possible, the same reference numerals will be used throughout the drawings to refer to the same or like parts.

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The present disclosure is described below, at first generally, then in detail on the basis of several exemplary embodiments. The features shown in combination with one another in the individual exemplary embodiments do not all have to be realized. In particular, individual features may also be omitted or combined in some other way with other features shown of the same exemplary embodiment or else of other exemplary embodiments.

Embodiments of the present disclosure relate to optical fiber production systems having fiber take-up systems including at least one LED, and to methods for producing coated optical fiber. Embodiments of the present disclosure increase cure efficiencies of optical fiber production systems and methods and effectively reduce costs associated such systems and methods.

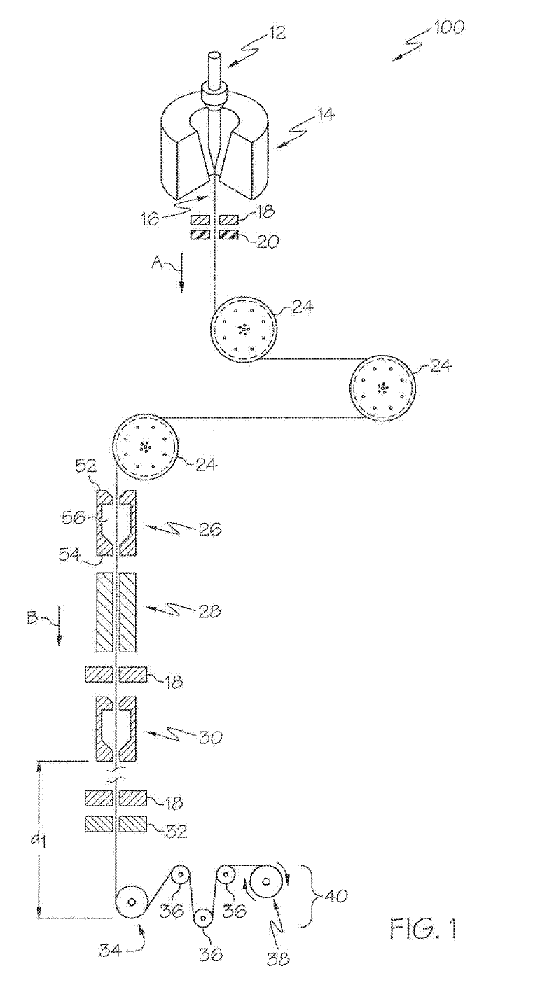

Referring to FIGS. 1-3, various embodiments of systems 100, 200, 300 for producing coated optical fiber are illustrated. The systems 100, 200, 300 may generally include a draw furnace 14 for heating an optical fiber preform 12 such that an optical fiber 16 may be drawn from the optical fiber preform 12. The preform 12 may include glass, such as silica-based glass, or any material suitable for the manufacture of optical fibers. The draw furnace 14 may be oriented along a first vertical pathway (A) such that an optical fiber 16 drawn from the optical fiber preform 12 exits the furnace along the first vertical pathway (A) in a downward direction.

After the optical fiber 16 exits the draw furnace 14, the diameter of the optical fiber 16 and the draw tension applied to the optical fiber 16 may be measured with non-contact sensors 18, 20.

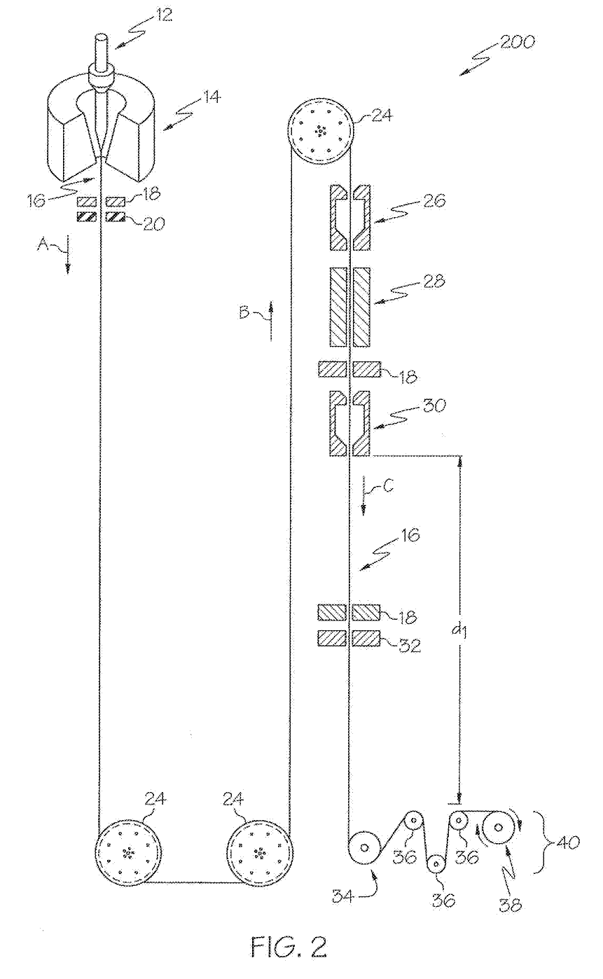

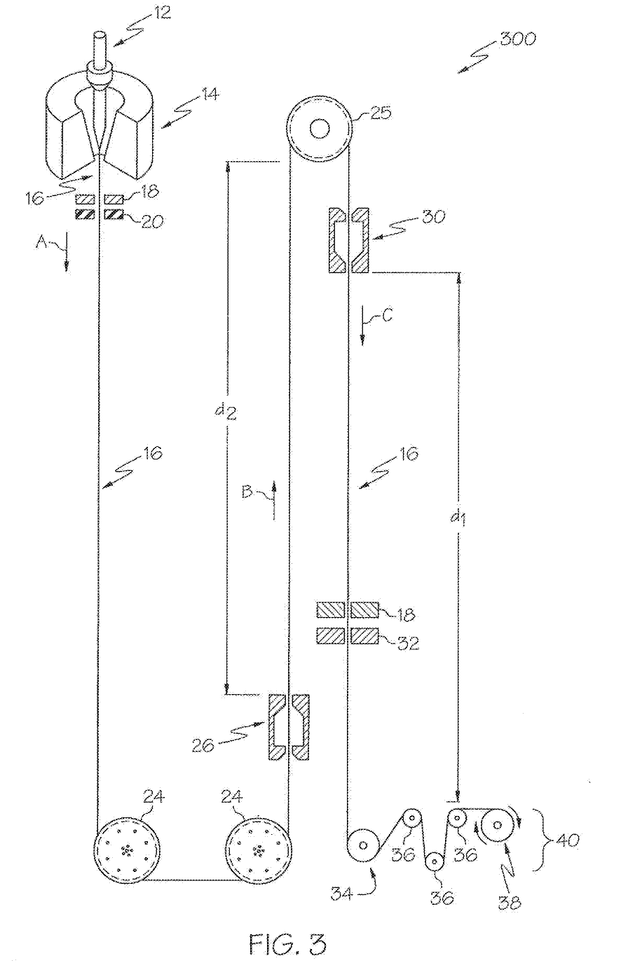

As depicted in FIGS. 1-3, after measurement by the non-contact sensors 18, 20, the optical fiber 16 may optionally be redirected from the first vertical pathway (A) to a second vertical pathway (B) wherein the second vertical pathway (B) is parallel with the first vertical pathway (A). As shown in the system 100 depicted in FIG. 1, the optical fiber 16 may be directed in a generally downward direction along the second vertical pathway (B) and the second vertical pathway (B) may be non-collinear with the first vertical pathway (A). Alternatively, the second vertical pathway (B) may be collinear with the first vertical pathway (A) and the optical fiber 16 is directed in a generally downward direction along both the first vertical pathway (A) and the second vertical pathway (B). As shown in the systems 200 and 300 depicted in FIGS. 2 and 3 respectively, after the optical fiber 16 has been redirected to the second vertical pathway (B), the optical fiber 16 may travel in a generally upward direction along the second vertical pathway (B). Further, it should be understood that, in order to facilitate redirecting the optical fiber from the first vertical pathway (A) to the second vertical pathway (B), the optical fiber 16 may be directed along one or more non-vertical pathways between the first vertical pathway (A) and the second vertical pathway (B), as is depicted in FIGS. 1-3.

It should be understood that, prior to receiving a protective coating, the optical fiber 16 is fragile and easily damaged, particularly when the uncoated optical fiber comes into mechanical contact with another solid. Accordingly, to maintain the quality of the optical fiber 16, it is desirable that contact between the optical fiber 16 and any solid surface or component be avoided prior to the optical fiber 16 receiving a protective coating. Therefore, to facilitate redirecting the optical fiber 16 without damaging the optical fiber 16, the optical fiber 16 may be routed through a non-contact mechanism which redirects the optical fiber 16 from the first vertical pathway (A) to the second vertical pathway (B) without mechanically contacting or touching the optical fiber 16. For example, referring to FIGS. 1-3, one or more fluid bearings 24 may be used to redirect the optical fiber 16 along various pathways such that the optical fiber 16 is not subject to mechanical contact until after the optical fiber 16 has been coated. The fluid bearings 24 may be of the type disclosed in U.S. Patent Application Publication No. US 2010/0281922 A1, which is incorporated in its entirety herein by reference, although various other types and configurations of fluid bearings may be used to facilitate non-contact redirection of an optical fiber.

Referring again to FIGS. 1-3, the systems 100, 200, 300 for producing coated optical fibers may include a plurality of fluid bearings 24 to redirect the optical fiber 16 from the first vertical pathway (A) to the second vertical pathway (B). For example, as shown in FIG. 1, three fluid bearings 24 are used to redirect the optical fiber 16 from the first pathway (A) to the second vertical pathway (B). In the systems shown in FIGS. 2 and 3, two fluid bearings are used to redirect the optical fiber from the first vertical pathway (A) to the second vertical pathway (B). When more than one fluid bearing is used to redirect the optical fiber from the first vertical pathway (A) to the second vertical pathway (B), the optical fiber 16 may be redirected along one or more intermediate pathways between the first vertical pathway (A) and the second vertical pathway (B) and the intermediate pathways may be of any orientation with respect to the first vertical pathway (A) and the second vertical pathway (B), as is generally depicted in FIGS. 1-3. However, it should be understood that a single fluid bearing 24 may also be used to redirect the optical fiber 16 from the first vertical pathway (A) to the second vertical pathway (B).

Further, it will be understood that, while the fluid bearings 24 depicted in FIGS. 1-3 function to redirect the optical fiber 16 from one pathway to another, the fluid bearings 24 may also operate as a cooling mechanism for cooling the optical fiber 16 after the optical fiber 16 exits the draw furnace 14. More specifically, the fluid cushion and associated fluid stream that supports the optical fiber 16 in the fluid bearing 24 may also serve to carry heat away from the optical fiber 16 thereby cooling the optical fiber 16. For example, the optical fiber 16 may be cooled to a temperature of about 20° C. to about 200° C. after exiting the fluid bearings 24. In another embodiment, the fluid bearings 24 may work in conjunction with a cooling mechanism (not shown) to cool the optical fiber 16. Cooling of the optical fiber 16 may also be facilitated by spacing the primary coating system 26 apart from the draw furnace 14 such that the optical fiber 16 is also subject to air cooling in addition to any cooling provided by the fluid bearings 24.

Referring now to the system 100 for producing an optical fiber shown in FIG. 1, after the optical fiber 16 is redirected from the first vertical pathway (A) to the second vertical pathway (B), the optical fiber 16 is passed through a primary coating system 26 where a primary coating is applied to the optical fiber 16 along the second vertical pathway (B). As shown in FIG. 1 the primary coating system 26 may be configured to apply a UV-curable primary coating to the optical fiber such as a UV-curable acrylate coating. When the primary coating system 26 is configured to apply a UV-curable primary coating to the optical fiber 16, the primary coating system 26 may include a guide die 52 having a first diameter and a sizing die 54 having a second, smaller diameter. Disposed between the guide die 52 and the sizing die 54 is a coating chamber 56. The coating chamber 56 is filled with the UV-curable coating material in liquid form. The optical fiber 16 enters the primary coating system 26 through the guide die 52 and passes through the coating chamber 56 where the UV-curable coating material is applied to the surface of the optical fiber 16. The optical fiber 16 then passes through the sizing die 54 where any excess coating material is removed as the optical fiber 16 exits the primary coating system 26 to achieve a coated optical fiber of a specified diameter corresponding to the diameter of the sizing die 54.

While FIG. 1 depicts the primary coating system 26 as having a guide die 52, a coating chamber 56 and sizing die 54 such that the primary coating system 26 is configured to apply a UV-curable primary coating to the optical fiber, it should be understood that the primary coating system 26 may be any suitable coating unit for applying a UV-curable primary coating to an optical fiber as may be presently known in the art or subsequently developed. Further, it should also be understood that the primary coating system 26 may be configured with additional guide and sizing dies such that multiple coatings may be applied to the optical fiber as it is passed through the primary coating system 26. For example, the primary coating system may apply a first UV-curable coating and a second UV-curable coating. According to embodiments of the present disclosure, the first and second UV-curable coatings may be the same material or may be different materials to enhance the optical and/or mechanical properties of the resultant coated optical fiber.

Still referring to the system 100 shown in FIG. 1, where the primary coating system 26 is configured to apply a UV-curable primary coating to the optical fiber 16, the system 100 may further include an irradiator 28 disposed along the second vertical pathway (B) such that, after the UV-curable coating is applied to the optical fiber 16, the optical fiber 16 with the UV-curable coating passes through the irradiator 28 where the UV-curable coating is cured or hardened. After exiting the irradiator 28, the optical fiber 16 may pass through a non-contact sensor where the diameter of the optical fiber 16 is measured. Thereafter, the optical fiber 16 may be passed through a secondary coating system 30 where a secondary coating is applied to the optical fiber 16 over the primary coating. The secondary coating may be a material having a suitable viscosity prior to curing that is capable of curing quickly to enable processing of the optical fiber. The secondary coating system 30 may include an extrusion die for applying the secondary coating to the optical fiber. However, it will be understood that the secondary coating system may employ various other dies and/or coating systems suitable for applying a secondary coating to the optical fiber 16 as may be currently known or subsequently developed.

Referring now to FIG. 3 where another system 300 for producing coated optical fiber is shown, after the optical fiber 16 is redirected from the first vertical pathway (A) to the second vertical pathway (B), the optical fiber 16 may be passed through a primary coating system 26 where a primary coating is applied to the optical fiber 16 along the second vertical pathway (B). The system 300 may further include a secondary coating system 30 disposed along a third vertical pathway (C) which is substantially parallel to the second vertical pathway (B). In order to direct the optical fiber 16 from the second vertical pathway (B) to the third vertical pathway (C), the system 300 may also include one or more pulleys 25 or bearings disposed between the primary coating system 26 and the secondary coating system 30 for redirecting the optical fiber 16 from the second vertical pathway (B) to the third vertical pathway (C). When mechanical contact with the coated optical fiber 16 is acceptable, the pulley 25 may be a mechanical pulley which contacts the optical fiber 16. Alternatively, the pulley 25 may include a non-contact mechanism for redirecting the coated optical fiber such as a fluid bearing. After the optical fiber 16 has been coated with a primary coating in the primary coating system 26, the optical fiber 16 is routed into the pulley 25 where it is redirected to the third vertical pathway (C). After the optical fiber has been redirected to the third vertical pathway (C), the optical fiber may be drawn along the third vertical pathway (C) in a generally downward direction.

After application of the primary coating along the second vertical pathway (B), the primary coating applied to the optical fiber 16 may have an elevated temperature and, as such, may be soft and susceptible to damage until cooling occurs. Accordingly, to cool the primary coating, and thereby prevent damage to the coating in subsequent processing stages, the pulley 25 or non-contact mechanism disposed between the primary coating system 26 and the secondary coating system 30 may be spaced apart from the primary coating system 26 by a distance (d₂) thereby permitting the primary coating to air cool before being redirected to the third vertical pathway (C). For example, the primary coating may have a temperature of from about 50° C. to about 100° C. when the optical fiber exits the primary coating system 26. By spacing the pulley 25 apart from the primary coating system 26, the primary coating may be air cooled to a temperature of less than about 50° C. so that the primary coating is solidified and less susceptible to damage when it is redirected to the third vertical pathway (C). In addition to spacing the pulley 25 or non-contact mechanism apart from the primary coating system 26 to facilitate cooling of the primary coating, a cooling mechanism (not shown) may be disposed between the primary coating system 26 and the pulley 25 or non-contact mechanism to assist in cooling the primary coating to the desired temperature range.

After the optical fiber 16 is redirected to the third vertical pathway (C), the optical fiber 16 is passed through the secondary coating system 30 where a secondary coating is applied to the optical fiber 16. The secondary coating system 30 may have a substantially similar configuration as the secondary coating system 30 discussed hereinabove with respect to FIG. 1.

Referring now to FIG. 2 showing another system 200 for producing coated optical fiber, after the optical fiber 16 is redirected from the first vertical pathway (A) to the second vertical pathway (B), the optical fiber is drawn along the second vertical pathway (B) in a generally upward direction where it is air-cooled. The optical fiber 16 is then routed into one or more additional fluid bearings 24 disposed along the second vertical pathway (B) where it is redirected to a third vertical pathway (C) which is substantially parallel to the second vertical pathway (B). In the system 200 shown in FIG. 2, a single fluid bearing 24 is disposed along the second vertical pathway (B) for redirecting the optical fiber 16 to the third vertical pathway (C). However, it should be understood that a plurality of fluid bearings 24 may be used to redirect the optical fiber 16 from the second vertical pathway (B) to the third vertical pathway (C). After being redirected to the third vertical pathway (C) the optical fiber 16 is drawn along the third vertical pathway (C) in a generally downward direction.

The system 200 may also include a primary coating system 26 and a secondary coating system 30 disposed along the third vertical pathway (C). The primary coating system 26 may be configured to apply a UV-curable primary coating. When the primary coating system 26 is configured to apply a UV-curable primary coating, as shown in FIG. 2, the system 200 may also include an irradiator 28. As discussed hereinabove, the primary coating system 26 may be configured to apply multiple UV-curable coatings to the optical fiber 16 as the optical fiber passes through the primary coating system 26. After being redirected to the third vertical pathway (C) from the second vertical pathway (B), the optical fiber 16 enters the primary coating system 26 where a UV-curable primary coating is applied to the optical fiber 16. Thereafter, the optical fiber enters irradiator 28 where the UV-curable primary coating is cured or hardened. In one embodiment, after the optical fiber exits the irradiator, the diameter of the optical fiber 16 may be measured with a non-contact sensor 18. The optical fiber 16 may then be passed through a secondary coating system 30 where a secondary coating is applied to the optical fiber 16 over the primary coating.

According to embodiments of the present disclosure, the system 100, 200, 300 may optionally include a colored coating system which applies a colored coating to the optical fiber 16. The colored coating system may be disposed after the secondary coating system 30 along any of the vertical pathways such that a colored coating layer is applied over the secondary coating as the optical fiber 16 passes through the color coating system. Alternatively, the colored coating system may be disposed between the primary coating system 26 and the secondary coating system 30 such that a colored coating layer is applied over the primary coating as the optical fiber 16 passes through the color coating system. Instead of the color coating system being separate from the other coating systems, the color coating system may include color concentrate reservoirs connected to the primary coating system 26 or the secondary coating system 30. Color concentrate from the color concentrate reservoirs may be provided to the primary coating system 26 or the secondary coating system 30 such that the color concentrate is mixed with the respective coating material and one of the primary coating and the secondary coating applied to the optical fiber 16 is a colored coating layer. According to the embodiments of the present disclosure, the colored coating system may also be configured to apply a colored coating layer of a first color wherein the colored coating layer includes a colored stripe of a second color that is different from the first color. The colored coating layer may be a UV-curable ink having one of a plurality of colors. The color coating layer may be one of the twelve colors of the standard color-coding described in the Telecommunications Industry Association's TIA-598C which is incorporated in its entirety herein by reference.

Referring now to FIGS. 1-3, after exiting the secondary coating system 30, the diameter of the coated optical fiber 16 may be measured using a non-contact sensor 18. Thereafter, a non-contact flaw detector 32 may be used to examine the coated optical fiber 16 for damage and/or flaws that may have occurred during the manufacture of the optical fiber 16. It should be understood that, after the optical fiber 16 has been coated, the optical fiber 16 is less susceptible to damage due to mechanical contact.

Still referring to FIGS. 1-3, after examination by the non-contact sensor 18 and flaw detector 32, the optical fiber 16, now coated with a primary coating or with a primary and secondary coating, is wound onto a fiber storage spool 38 with a fiber take-up system 40. The fiber take-up system 40 utilizes drawing mechanisms 36 and tensioning pulleys 34 to facilitate winding the optical fiber 16 onto a fiber storage spool 38. The tensioning pulley 34 may provide the necessary tension to the optical fiber 16 as the optical fiber is drawn through the system 100, 200, 300. Accordingly, the fiber take-up system 40 directly contacts optical fiber 16 in order to both wind the optical fiber onto a fiber storage spool 38 as well as to provide the desired tension on the optical fiber 16 as it is drawn through the various stages of the systems 100, 200, 300. As will be discussed in more detail below, the fiber take-up system 40 may include guards or shields which prevent whipping damage to the optical fiber 16 wound on the fiber storage spool 38. Such whipping damage may be caused by broken portions of fiber that break due to forces applied during winding of the optical fiber 16.

As the optical fiber 16 leaves the secondary coating system 30, the secondary coating applied to the optical fiber 16 may have an elevated temperature and, as such, the secondary coating may be soft and susceptible to damage through mechanical contact. Accordingly, the secondary coating may be cooled before the optical fiber 16 is be contacted by the fiber take-up system 40. To facilitate cooling of the secondary coating, the fiber take-up system 40 may be spaced apart from the secondary coating system 30 by a distance (d₁) such that the secondary coating is air cooled and solidified before entering the fiber take-up system 40. For example, prior to entering the fiber take-up system 40, the secondary coating may be cooled to a temperature from about 30° C. to about 100° C. so that the secondary coating is not damaged by contact with the fiber take-up system 40. Alternatively, in addition to spacing the fiber take-up system from the secondary coating system 30 to facilitate cooling the secondary coating, a cooling mechanism (not shown) may be disposed between the secondary coating system 30 and the fiber take-up system 40.

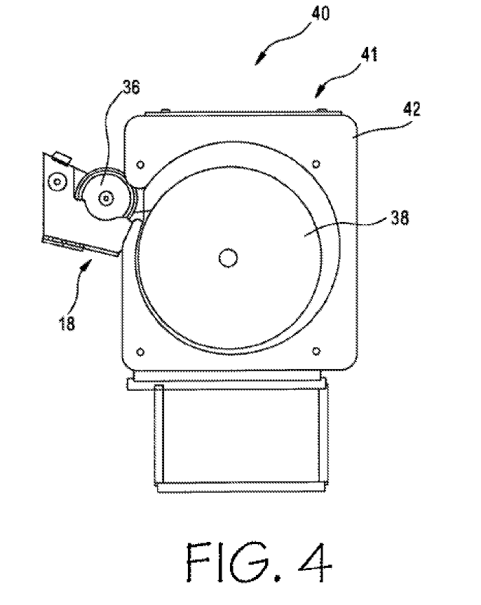

Referring now to FIG. 4, an embodiment of the fiber take-up system 40 according to the present disclosure is shown in more detail. The fiber take-up system 40 includes a fiber winding device 41 having a whip shield 42 that substantially surrounds a fiber storage spool 38 on which fiber is wound. The whip shield 42 may be configured to prevent whipping damage to the optical fiber 16 wound on the fiber storage spool 38 which is caused when broken portions of fiber that break due to forces applied during winding of the optical fiber 16 contact the optical fiber 16 on the fiber storage spool 38 as the fiber storage spool 38 continues to rotate. The whip shield 42 also prevents broken portions of fiber from contacting and damaging objects, or contacting and injuring individuals, situated near the fiber take-up system 40. Coated optical fiber 16 is directed to a fiber entry whip reducer 18 by drawing mechanisms 36 and tensioning pulleys 34 (shown in FIGS. 1-3). The coated optical fiber 16 is directed through the fiber entry whip reducer 18 to the fiber winding device 41, where the fiber entry whip reducer 18 is configured to reduce or eliminate the whip action of broken portions of the coated optical fiber 16 as it enters the fiber winding device 41. Coated optical fiber 16 is wound onto the fiber storage spool 38 at a relatively high rate of speed, e.g., speeds of about 30 m/s or higher, while also being also maintained under a relatively high tension to ensure proper winding onto the fiber storage spool 38. The fiber take-up system 40 may be of the types disclosed in U.S. Pat. No. 6,152,399 and U.S. Pat. No. 6,299,097, which are incorporated in their entirety herein by reference, although various other types and configurations of fiber take-up systems may be incorporated into systems for producing coated optical fiber.

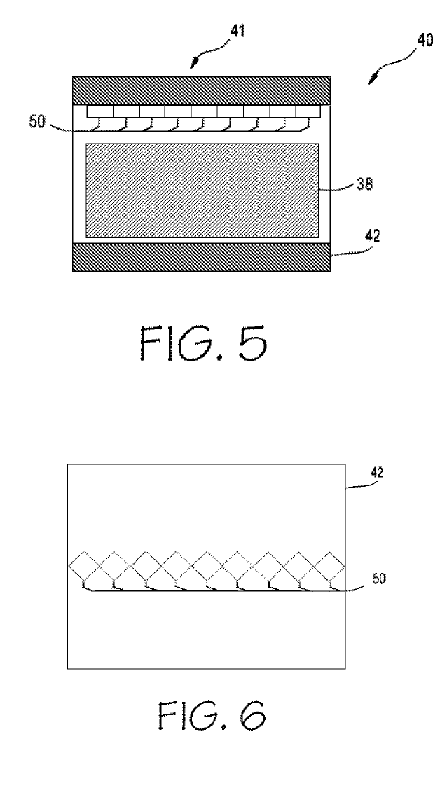

FIG. 5 illustrates a whip shield 42 including at least one light emitting diode (LED) positioned in the interior, for example on an interior wall, of the whip shield 42. As shown in the cross section of FIG. 5, and as further shown in the front view of FIG. 6, the at least one LED 50 may include a plurality of LEDs which span a width substantially equal to the width of the fiber storage spool 38. According to embodiments of the present disclosure, the plurality of LEDs may be situated to form at least one row of LEDs. Also as shown in FIG. 5, the at least one LED 50 may be physically attached to an interior wall of the whip shield 42 using an adhesive, a mechanical fastener, or any other known device or method for physical attachment. Alternatively, the whip shield 42 may include the at least one LED 50 integrated into the interior wall of the whip shield 42. The at least one LED 50 may also be integrated into, or physically attached to, an arrangement, such as an LED bar, where the arrangement is physically attached to an interior wall of the whip shield 42. The at least one LED 50 is configured to emit UV light in the direction of coated optical fiber 16 wound on the fiber storage spool 38 to expose the coated optical fiber 16 to the UV light to cure the coating. According to embodiments of the present disclosure, the at least one LED 50 may be configured to emit UV light such that all portions of the coated optical fiber 16 wound on the fiber storage spool 38 are exposed to a substantially equal amount of UV light.

As the fiber take-up system 40 such as the one illustrated in FIG. 4 substantially surrounds the fiber storage spool 38, the area around the fiber storage spool 38 may be limited. This limited space limits the feasibility of situating conventional UV lamps near the fiber storage spool 38 to cure the coating on the coated optical fiber 16 wound on the fiber storage spool 38. Conventional UV lamps include a reflector to direct light to the coated optical fiber 16 and also include cooling systems to dissipate the heat generated by the UV lamps. These features of conventional UV lamps require more space than is available in a fiber take-up system 40 such as is described in the present disclosure. The at least one LED 50 described herein takes up less space than a conventional UV lamp. For example, the at least one LED 50 may be as small as about 1 mm². Also, the at least one LED 50 is configured to emit photons unidirectionally from the surface of the at least one LED 50. As such, large reflectors such as those included in conventional UV lamps are not needed to direct the UV light to the coated optical fiber 16. Furthermore, the at least one LED 50 is configured to generate low amounts of heat and cooling systems are generally not needed to dissipate the heat generated by the at least one LED 50. According to embodiments of the present disclosure, the rotation of the fiber storage spool 38 may provide convective cooling of the at least one LED 50 which may be adequate to dissipate the heat generated by the at least one LED 50.

According to embodiments of the present disclosure, positioning the at least one LED 50 on an interior wall of the whip shield 42 can also increase the efficiency of curing the coated optical fiber 16. Such positioning of the at least one LED 50 increases the period of time the coated optical fiber 16 is exposed to the UV light emitted from the at least one LED 50. Whereas the coated optical fiber 16 is exposed to UV light for less than about 100 milliseconds when the coating is cured on the draw tower, the coated optical fiber 16 wound on the fiber storage spool 38 may be exposed to UV light from the at least one LED 50 for greater than about 1.0 second. For example, optical fiber 16 wound on the fiber storage spool 38 may be exposed to UV light from the at least one LED 50 for greater than about 2.0 seconds, or greater than about 5.0 seconds, or greater than about 10 seconds, or even greater than about 20 seconds. The optical fiber 16 wound on the fiber storage spool 38 may be exposed to UV light from the at least one LED 50 for between about 1.0 second and about 100 seconds, or between about 5.0 seconds and about 80 seconds, or between about 10 second and about 70 seconds, or even between about 20 seconds and about 60 seconds. As such, embodiments of the present disclosure may increase the period of exposure of the coated optical fiber 16 to UV light by between about 200 times and about 1,000 times the period of exposure of the coated optical fiber 16 to UV light during the process of drawing the optical fiber on the draw tower. As previously discussed, the at least one LED 50 is configured to emit photons unidirectionally from the surface of the at least one LED 50. In addition to the increased period of time the coated optical fiber 16 is exposed to UV light, unidirectional emission of photons leads to substantially all of the light emitted from the at least one LED 50 being absorbed by the coated optical fiber 16. This enables increased light absorption as compared to conventional UV lamps, which in turn increases the efficiency of curing the coated optical fiber 16.

According to embodiments of the present disclosure, a method for curing optical fiber coatings in an optical fiber take-up system is also provided. The method includes drawing an optical fiber from a draw furnace along a vertical pathway and applying at least one coating to the optical fiber with at least one coating system to form a coated optical fiber. Prior to applying the at least one coating, the optical fiber may optionally be redirected from the vertical pathway to a second vertical pathway wherein the second vertical pathway. According to embodiments of the present disclosure, the optical fiber may be redirected from the first vertical pathway to the second vertical pathway through at least one fluid bearing.

The method also includes curing the at least one coating while drawing the coated optical fiber along the pathway. Optionally the method may include applying at least two coatings to the optical fiber with at least two coating systems to form a coated optical fiber. Where at least two coatings are applied to the optical fiber, the method may include curing a first coating prior to applying a subsequently applied coating. Prior to applying the subsequently applied coating, the method may include cooling the optical fiber to a temperature of less than about 50° C. to further solidify the first coating. Where a subsequently applied coating is applied, the method further includes curing the subsequently applied coating while drawing the coated optical fiber along the pathway. Additionally, subsequent to applying the subsequently applied coating, the method may include cooling the optical fiber to a temperature of between about 30° C. and about 100° C. to further solidify the subsequently applied coating. Cooling the optical fiber may include air cooling the optical fiber.

The method further includes winding the optical fiber onto a fiber storage spool of a fiber take-up system, wherein winding the optical fiber also includes directing UV light from at least one LED to cure the at least one coating of the coated optical fiber. Directing UV light from the at least one LED may include exposing all portions of the coated optical fiber wound on the fiber storage spool to a substantially equal amount of UV light. Additionally, directing UV light from the at least one LED may include exposing the coated optical fiber to the UV light such that substantially all the UV light is absorbed by the coated optical fiber.

The coated optical fiber may be exposed to UV light from the at least one LED for greater than about 1.0 second. For example, optical fiber 16 wound on the fiber storage spool 38 may be exposed to UV light from the at least one LED 50 for greater than about 2.0 seconds, or greater than about 5.0 seconds, or greater than about 10 seconds, or even greater than about 20 seconds. The optical fiber 16 wound on the fiber storage spool 38 may be exposed to UV light from the at least one LED 50 for between about 1.0 second and about 100 seconds, or between about 5.0 seconds and about 80 seconds, or between about 10 second and about 70 seconds, or even between about 20 seconds and about 60 seconds.

It will be apparent to those skilled in the art that various modifications and variations can be made without departing from the spirit or scope of the present disclosure.

What is claimed is:

1. An optical fiber production system comprising:
a draw furnace from which an optical fiber is drawn along a first vertical pathway;
at least one coating system where at least one coating is applied to the optical fiber;
an irradiator in which the at least one coating is cured; and
a fiber take-up system comprising a fiber storage spool, a whip shield that substantially surrounds the fiber storage spool and at least one light emitting diode (LED) positioned in the interior of the whip shield, wherein the at least one LED directs UV light to coated optical fiber in the fiber take-up system.

2. The optical fiber production system of claim 1, wherein the at least one LED is integrated into an interior wall of the whip shield.

3. The optical fiber production system of claim 1, wherein the at least one LED is physically attached to an interior wall of the whip shield.

4. The optical fiber production system of claim 1, wherein the at least one LED is attached to or integrated into an arrangement that is physically attached to an interior wall of the whip shield.

5. The optical fiber production system of claim 1, wherein the arrangement comprises an LED bar.

6. The optical fiber production system of claim 1 comprising a plurality of LEDs.

7. The optical fiber production system of claim 6, wherein the plurality of LEDs spans a width substantially equal to the width of the fiber storage spool.

8. The optical fiber production system of claim 1, wherein the at least one LED has an area of about 1 mm².

9. The optical fiber production system of claim 1, further comprising at least one non-contact mechanism which redirects the optical fiber from the first vertical pathway to a second vertical pathway.

10. The optical fiber production system of claim 9, wherein the non-contact mechanism comprises at least one fluid bearing.

11. The optical fiber production system of claim 9, wherein the second vertical pathway is collinear with the first vertical pathway.

12. The optical fiber production system of claim 9, wherein the second vertical pathway is non-collinear with the first vertical pathway.

13. A method for producing a coated optical fiber, the method comprising:
drawing an optical fiber from a draw furnace along a first vertical pathway;
applying at least one coating to the optical fiber with at least one coating system to form a coated optical fiber;
curing the at least one coating while drawing the coated optical fiber along the first vertical pathway; and
winding the coated optical fiber onto a fiber storage spool of a fiber take-up system, wherein winding the optical fiber comprises directing UV light from at least one LED to cure the at least one coating of the coated optical fiber.

14. The method of claim 13, wherein directing UV light from the at least one LED comprises exposing all portions of the coated optical fiber to a substantially equal amount of UV light.

15. The method of claim 13, wherein directing UV light from the at least one LED comprises exposing the coated optical fiber to UV light such that substantially all the UV light is absorbed by the coated optical fiber.

16. The method of claim 13, further comprising, prior to applying the at least one coating to the optical fiber, redirecting the optical fiber from the first vertical pathway to a second vertical pathway.

17. The method of claim 16, wherein redirecting the optical fiber from the first vertical pathway to a second vertical pathway comprises redirecting the optical fiber through at least one fluid bearing.

18. The method of claim 13, wherein applying at least one coating to the optical fiber comprises applying at least two coatings to the optical fiber with at least two coating systems to form a coated optical fiber.

19. The method of claim 18, wherein curing the at least one coating comprises curing a first of the at least two coatings prior to applying a subsequently applied coating.

20. The method of claim 19, further comprising, prior to applying the subsequently applied coating, cooling the optical fiber to a temperature of less than about 50° C.

21. The method of claim 20, wherein cooling the optical fiber comprises air cooling.

22. The method of claim 19, further comprising, subsequent to curing the subsequently applied coating, cooling the optical fiber to a temperature of between about 30° C. and about 100° C.

23. The method of claim 22, wherein cooling the optical fiber comprises air cooling.

24. The method of claim 13, directing UV light from the at least one LED comprises exposing the coated optical fiber to UV light for greater than about 1.0 second.

25. The method of claim 13, wherein directing UV light from the at least one LED comprises exposing the coated optical fiber to UV light for between about 1.0 second and about 100 seconds.
